(19) United States
(12) Patent Application Publication
(10) Pub. No.: US 2021/0409529 A1
(43) Pub. Date: Dec. 30, 2021

(54) TERMINAL DEVICE

(71) Applicant: Wuhan China Star Optoelectronics Technology Co., Ltd., Wuhan, Hubei (CN)

(72) Inventor: Pengfei Yu, Wuhan, Hubei (CN)

(21) Appl. No.: 16/603,784

(22) PCT Filed: Apr. 17, 2019
(86) PCT No.: PCT/CN2019/083003

§ 371 Date: Oct. 8, 2019

(30) Foreign Application Priority Data
Nov. 28, 2018 (CN) 201811436520.1

(51) Int. Cl. H04M 1/02; G06F 1/16

(52) U.S. Cl. CPC H04M 1/0264; G06F 1/1615; G06F 1/1686; G06F 1/1675

(57) ABSTRACT

A terminal device includes a frame and a touched notch screen and a back plate which are disposed one behind the other. A camera assembly is disposed at a concave place located at an upside section of the touched notch screen. The camera assembly includes a case body and a camera which is disposed therein. The case body includes a front transparent panel section and a rear transparent panel section which are oppositely disposed at a front side and a rear side, wherein the front transparent panel section and the touched notch screen are combined to form a plane, the rear transparent panel section and the back plate are combined to form a plane. The camera is disposed on a rotatable body which is between the front and the rear transparent panel section and can only rotate 180 degrees clockwisely or counter clockwisely.

### FIELD OF INVENTION

The present disclosure relates to a terminal electronic device which is utilized by plane touch control, and more particularly to a smart phone and a smart pad.

### BACKGROUND OF INVENTION

With the continuous development of the display industry, wherein the maximized screen ratio of display panels, the maximized display area and the more stunning display performance of full screen technology have gradually become the main stream.

With the full screen has become the trend of the industry, mobile phones are generally selected 18:9 full screens which the screen ratio is generally greater than 80%, and the edges of the screens are very closed to the housings of mobile phones. However, the aspect ratio of conventional mobile phones is 16:9, which is rectangle with right angles on the four edges. To dispose a front camera, a sensor and other electronic devices, there will be a certain distance between the edges of the screen and the frame of the mobile phone.

Regarding the full screen mobile phone, if applying a conventional right angle solution, there will be no space to dispose electronic devices. Meanwhile, if the screen is near to the edge of the housing, which will make the impact greater and easier to break the screen when the screen was fallen. Therefore, to decrease the possibility of breaking the screen and reserve the place for elements, it is necessary to process the screen into a non-right angle notch shaped cut.

The so-called ‘notch shaped cut’ is according to different requirements to perform a R-corner cut, a U-shaped groove cut, a C-corner cut, etc. to the screen. It has two purposes: first is to make the C-corner cut or the R-corner cut on the four corners of the screen, and then adding such buffer foam to strengthen the edges to prevent breaking the screen. Second is to make the U-shaped cut on the upper screen to reserve space for a front camera, a distance sensor, a receiver and other parts.

This is because present camera suppliers cannot provide the solution for the camera under the screen, and the main stream 3D-scan comes from coordinating with multiple cameras. However, the internal space of the mobile phone is so limited, if these elements are all arranged in the screen, the front camera, the rear camera, sensors and such electronic elements will not have sufficient space to be disposed.

Specifically, taking mobile phones as an example, the general public have more and more requirements for camera performance, which make the industry have higher and higher parameters requirement for cameras. Meanwhile, there are not only disposed a front camera but also disposed a rear camera on the mobile phone. The setting of these cameras is inevitable to occupy more space, and how to dispose these cameras reasonably in the such limited space and satisfy high performance of shooting requirement has become a difficulty to the industry.

### SUMMARY OF INVENTION

One aspect of the present disclosure is for providing a terminal device, which applying a new style disposed way and combines the characteristic of the shape of the touched notch screen itself to realize the maximum of the display area of the touched notch screen.

The technical solutions which the present disclosure applies as follows:

A terminal device, which includes a frame and a touched notch screen and a back plate which are disposed one behind the other. Wherein a camera assembly is disposed at a concave place located at an upside section of the touched notch screen. The camera assembly includes a case body and a camera which is disposed therein; the case body includes a front transparent panel section and a rear transparent panel section which are oppositely disposed at a front side and a rear side, wherein the front transparent panel section and the touched notch screen are combined to form a plane, the rear transparent panel section and the back plate are combined to form a plane. The camera is disposed on a rotatable body, the rotatable body is between the front transparent panel section and the rear transparent panel section and can only rotate 180 degrees clockwisely or counter clockwisely to make the shooting direction can be changed from a direction along the touched notch screen to a direction along the back plate, and then realizes the transform between front shooting or rear shooting for the camera.

Further, in different embodiments, wherein the rotatable body is a cylindrical structure. Preferably is a cylindrical structure, but are not limited to.

Further, in different embodiments, wherein one end of the rotatable body is disposed on the frame through a shaft hole on the frame through a shaft hole.

Further, in different embodiments, wherein one end of the rotatable body is connected to a driving motor, and rotatable in 180 degrees under the driving of the driving motor.

Further, in different embodiments, wherein one end of the rotatable body is connected to an output shaft of the driving motor, and thereby making the rotatable body being hanged between the front transparent panel section and the rear transparent panel section by connecting with the output shaft of the driving motor.

Further, in different embodiments, wherein the driving motor according to the setting can be only predetermined to output clockwisely or output counter clockwisely, thereby realizing the rotatable body to rotate 180 degrees clockwisely or 180 degrees counter clockwisely.

Further, in different embodiments, wherein the driving motor is connected to a processing unit and according to the instruction of the processing unit to rotate 180 degrees clockwisely or counter clockwisely.

Further, in different embodiments, wherein the touched notch screen receives the requirement of rotating the camera from an instruction of an external input, and transmit the instruction to the processing unit.

Further, in different embodiments, wherein the camera includes a dual-camera lens or tri-camera lens which are disposed side by side on the rotatable body.

Further, in different embodiments, wherein the terminal device includes a portable smart terminal device. For example, smart phones, smart pads and terminal computers, etc.

Relative to the prior art, the beneficial effects of the present disclosure are as follow: The present disclosure relates to a terminal device, which applies a rotatable camera structure, through rotating the camera 180 degrees to realize the capability of setting the camera for transforming between front shooting and rear shooting, thereby realizing the two in one sharing for the front and the rear camera.

In this way, not only saves the limited space of the terminal device, but also saves the cost of the camera product by share the camera.

Further, the rotatable camera structure is further combined with the touched notch screen structure, and disposed the rotatable camera structure at the notched place of the concave place of the middle of the upper touched notch screen, utilizing the region which cannot perform images display effectively, and meanwhile realizes the maximum of the display area of the touched notch screen.

### DESCRIPTION OF DRAWINGS

To more clearly illustrate the technical solutions of the embodiments of the present disclosure, the accompanying figures of the present disclosure will be described in brief. Obviously, the accompanying figures described below are only part of the embodiments of the present disclosure, from which figures those skilled in the art can derive further figures without making any inventive efforts.

FIG. 1 is a schematic diagram of a terminal device of an embodiment of the present disclosure.

FIG. 2 is the terminal device illustrated in FIG. 1, which includes sectional schematic diagram of the camera assembly.

### DETAILED DESCRIPTION OF PREFERRED EMBODIMENTS

The technical solutions of a terminal device according to the present disclosure will be further described in detail as follow with reference to the accompanying drawings and embodiments.

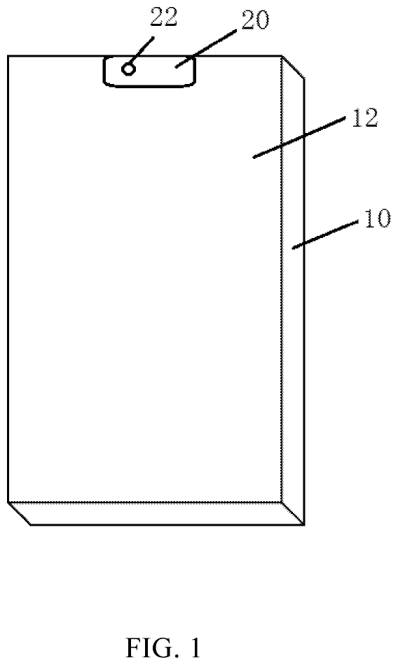

Referring to FIG. 1, the present disclosure provides a terminal device, which includes a frame 10, and a touched notch screen 12 and a back plate which are disposed one behind the other. Wherein a camera assembly is disposed at a concave place located at an upside section of the touched notch screen 12.

The camera assembly includes a case body 20 and a camera 22 which is disposed therein. The case body 20 includes a front transparent panel section and a rear transparent panel section which are oppositely disposed at a front side and a rear side, wherein the front transparent panel section and the touched notch screen are combined to form a plane, the rear transparent panel section and the back plate are combined to form a plane. So that, making the case body 20 can be embedded into the notched place of the touched notch screen suitably, and can be combined with it into one body and will not influence the effective display area of the touched notch screen 12. The front transparent panel section and the rear transparent panel of the case body 20 which are oppositely disposed at a front side and a rear side are transparent, which are for not influencing the shooting operation of the camera 22 disposed therein.

The camera 22 can rotate 180 degrees clockwisely or counter clockwisely in the case body 20, which is for making the effect for realizing the camera 22 to transform from front camera to rear camera. Relate to the terminal device disposed a front camera and a rear camera respectively, the configuration of the present disclosure on one hand can save the cost of the camera, on the other hand can save the limited space in the terminal device.

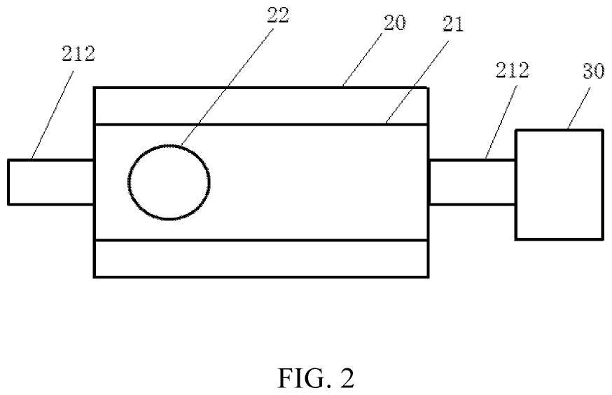

Further, in a specific embodiment of the rotatable configuration of the camera. Referring to FIG. 2, a rotatable body 21 which is disposed in the case body 20, and the camera 22 is disposed on the rotatable body 21. The rotatable body 21 is preferably a cylindrical structure to rotate for convenience, and the two ends of which is disposed a rotation shaft 212. One end of the rotation shaft 212 can be disposed on the frame 10 of the terminal device through a shaft hole, and another end is connected to an output shaft of a driving motor 30, and under the driving of the driving motor 30 to rotate 180 degrees, or the output shaft of the driving motor 30 is connected to one end of body 21 directly, and there is no need to additionally dispose the rotation shaft 212 between the both.

Further, in different embodiments, the rotatable body 21 is not necessarily connected to the frame 10, one end of the rotatable body 21 can also only be connected to the output shaft of the driving motor 30, thereby making the rotatable body 21 hanged between the front transparent panel section and the rear transparent panel section of the case body 20 by connecting with the output shaft of the driving motor 30.

The driving motor is connected to the processing unit of the terminal device and according to the instruction of the processing unit to rotate 180 degrees. The driving motor 30 according to the setting can be only predetermined to output clockwisely or output counter clockwisely, so that realize the rotatable body 21 to rotate 180 degrees clockwisely or 180 degrees counter clockwisely and cannot rotate into other degrees. In this way of setting, making the camera 22 can be operated more easily, conveniently and practically.

Further, the instruction outputted from the processing unit to the driving motor 30 can be outputted according to receiving the rotated instruction from external through the touched notch screen 12. Further, the rotatable body 21 can according to the requirement to dispose dual-camera lens or tri-camera lens or other necessary elements side by side, for example, light-emitting diode (LED) indicator lights, infrared (IR) holes, etc. Wherein the specific number of the camera can be decided based on the requirement, and there is no limited. The configuration of the elements is also based on the requirement, and there is no limited.

Further, in different embodiments, the terminal device includes a portable smart terminal device. For example, smart phones, smart pads and terminal computers, etc.

The present disclosure relates to a terminal device, which applies a rotatable camera structure, through rotating the camera 180 degrees to realize the capability of setting the camera for transforming between front shooting and rear shooting, thereby realizes the two in one sharing for the front and the rear camera. In this way, not only saves the limited space of the terminal device, but also saves the cost of the camera product by share the camera.

Further, the rotatable camera structure is further combined with the touched notch screen structure, and disposed the rotatable camera structure at the notched place of the concave place of the middle of the upper touched notch screen, utilizing the region which cannot perform images display effectively, and meanwhile realizes the maximum of the display area of the touched notch screen.

The technical scope of the present disclosure is not limited to the above description, and those skilled in the art can make various modifications and changes to the above embodiments without departing from the technical idea of the present disclosure, and these modifications and changes are all within the scope of the present disclosure.

What is claimed is:

1. A terminal device, comprising a frame and a touched notch screen and a back plate which are disposed one behind the other, wherein a camera assembly is disposed at a concave place located at an upside section of the touched notch screen;
wherein camera assembly comprises a case body and a camera which is disposed therein; the case body comprises a front transparent panel section and a rear transparent panel section which are oppositely disposed at a front side and a rear side, wherein the front transparent panel section and the touched notch screen are combined to form a plane, the rear transparent panel section and the back plate are combined to form a plane; and
wherein the camera is disposed on a rotatable body, the rotatable body is between the front transparent panel section and the rear transparent panel section and can only rotate 180 degrees clockwisely or counter clockwisely to make the shooting direction can be changed from a direction along the touched notch screen to a direction along the back plate, and then realizes the transform between front shooting or rear shooting for the camera.

2. The terminal device as claimed in claim 1, wherein the rotatable body is a cylindrical structure.

3. The terminal device as claimed in claim 1, wherein one end of the rotatable body is disposed on the frame through a shaft hole.

4. The terminal device as claimed in claim 1, wherein one end of the rotatable body is connected to a driving motor, and rotatable in 180 degrees under the driving of the driving motor.

5. The terminal device as claimed in claim 4, wherein one end of the rotatable body is connected to an output shaft of the driving motor, and thereby making the rotatable body being hanged between the front transparent panel section and the rear transparent panel section by connecting with the output shaft of the driving motor.

6. The terminal device as claimed in claim 4, wherein the driving motor according to the setting can be only predetermined to output clockwisely or output counter clockwisely, thereby realizing the rotatable body to rotate 180 degrees clockwisely or 180 degrees counter clockwisely.

7. The terminal device as claimed in claim 4, wherein the driving motor is connected to a processing unit and according to the instruction of the processing unit to rotate 180 degrees clockwisely or counter clockwisely.

8. The terminal device as claimed in claim 7, wherein the touched notch screen receives the requirement of rotating the camera from an instruction of an external input, and transmit the instruction to the processing unit.

9. The terminal device as claimed in claim 1, wherein the camera comprising a dual-camera lens or tri-camera lens which are disposed side by side on the rotatable body.

10. The terminal device as claimed in claim 1, wherein the terminal device comprises a portable smart terminal device.
